(19) United States
(12) Patent Application Publication
(10) Pub. No.: US 2006/0055191 A1
(43) Pub. Date: Mar. 16, 2006

(54) Apparatus for lifting and transport of hot water heater

(76) Inventor: Gary A. Isaacson JR., San Diego, CA (US)

Correspondence Address: JAMES E. BRUNTON, ESQ., P. O. BOX 29000, GLENDALE, CA, 91209, US

(21) Appl. No.: 11/266,871

(22) Filed: Nov. 3, 2005

Related U.S. Application Data
(63) Continuation-in-part of application No. 10/796,837, filed on Mar. 8, 2004, now abandoned.

(51) Int. Cl. B65G 7/12

(52) U.S. Cl. 294/152

(57) ABSTRACT

A lifting and transport strap assembly for lifting and transporting bulky articles which includes a main strap assembly for circumscribing at least a portion of the bulky article, first and second spaced-apart side straps connected to the main strap assembly for engaging the sides of the bulky article and a bottom strap spanning the side straps for engaging the bottom of the bulky article. Gripping rings are affixed to the ends of the main strap assembly to assist in gripping the apparatus and buckle loops are provided for adjusting the length of the main strap of the main strap assembly and for adjusting the length of the side straps so that the apparatus can be used to lift and transport articles of various sizes.

### BACKGROUNG OF THE INVENTION

This is a Continuation-In-Part Application of co-pending U.S. Ser. No. 10/796,837 filed Mar. 8, 2004, Docket No. 004-04

### FIELD OF THE INVENTION

The present invention relates generally to apparatus for the lifting and transport of bulky articles. More particularly, the invention concerns a lifting and transport apparatus that is specially designed for the lifting and transport of hot water heaters.

### DISCUSSION OF THE PRIOR ART

During the transport and installation of hot water heaters, the bulky and often quite heavy hot water heater must be moved into position within very tight quarters, such as water heater cabinets and specially designed water heater enclosures. Because of the tight quarters, it is difficult for more than one man to move the hot water heater into position. Accordingly, this cumbersome task often falls on a single installer. A primary object of the present invention is to provide a sample; easy to use lifting and transport strap assembly that enables one person to quickly and easily move the hot water heater into position.

In the past, the transport of hot water heaters has generally been accomplished through the use of two wheeled dollies. However, such dollies are quite cumbersome to use and provide little assistance to the installer in finally positioning the hot water heater within the hot water heater closet or like enclosure. More particularly, while the dolly can be used to transport the hot water heater to the vicinity of the water heater closet, actually positioning the hot water heater within the closet requires that the hot water heater be removed from the dolly and manually positioned within the hot water heater closet primarily by a single installer. Since the typical 40 gallon hot water heater weighs well in excess of 130 pounds, positioning the hot water heater comprises a formidable task. Additionally, since the typical hot water heater is over 18 inches in diameter and over 55 inches in height, gripping the hot water heater in a manner to position it within the hot water heater enclosure is most difficult. These are the problems that the apparatus of the present invention seeks to overcome by providing a uniquely designed lifting and transport strap that can be conveniently positioned around and about the hot water heater to enable it to be lifted and positioned by a single installer.

### SUMMARY OF THE INVENTION

By way of summary, one form of the lifting and transport strap assembly of the present invention for lifting and transporting bulky articles comprises a main strap assembly for circumscribing at least a portion of the bulky article, first and second spaced-apart side straps connected to the main strap assembly for engaging the sides of the bulky article and a bottom strap spanning the side straps for engaging the bottom of the bulky article. Gripping rings are affixed to the ends of the main strap assembly to assist in gripping the apparatus and means are provided for adjusting the length of the main strap assembly and for adjusting the length of the side straps so that the apparatus can be used to lift and transport articles of various sizes.

With the foregoing in mind it is an object of the present invention to provide a lifting and transport strap assembly that can be used by one man to expeditiously lift and transport bulky articles such as hot water heaters.

Another object of the invention is to provide a lifting and transport strap assembly of the aforementioned character that is adjustable so that it can be used to lift and transport articles of various sizes.

Another object of the invention is to provide a lifting and transport strap assembly as described in the preceding paragraphs that is easily connected to the article to be lifted and tends to stabilize the article during the lifting and transport step.

Another object of the invention is to provide a lifting and transport strap assembly for lifting articles, such as hot water heaters, which is designed in a manner such that the article to be transported will not be dented or otherwise damaged during the lifting and transport operation.

Another object of the invention is to provide a lifting and transport strap assembly of the character described that is of a durable and rugged construction.

Another object of the invention of it is to provide a lifting and transport strap assembly of the class described that is of a simple construction that can be inexpensively manufactured.

### BRIEF DESCRIPTION OF THE DRAWINGS

FIG. 1 is a generally perspective view of one form of the lifting and transport strap assembly of the present invention showing the apparatus positioned about a conventional hot water heater.

FIG. 2 is a generally perspective front view of the form of the lifting and transport strap assembly shown in FIG. 1.

FIG. 3 is a generally perspective rear view of the form of the lifting and transport strap assembly shown in FIG. 1.

FIG. 4 is a top plan view of the lifting and transport strap assembly shown in FIG. 1.

FIG. 5 is a greatly enlarged top plan view of the right hand portion of the strap assembly shown in FIG. 4.

FIG. 6 is an enlarged, generally perspective view of the main strap assembly of the apparatus.

FIG. 7 is a generally perspective, exploded view of the main strap assembly of the apparatus.

FIG. 8 is a generally perspective view of an alternate form of the lifting and transport strap assembly of the present invention showing the apparatus positioned about a conventional hot water heater.

FIG. 9 is a generally perspective, exploded view of a portion of the main strap assembly of the alternate form of the apparatus.

FIG. 10 is an enlarged, generally perspective view of the main strap assembly of the alternate form of the apparatus.

### DESCRIPTION OF THE INVENTION

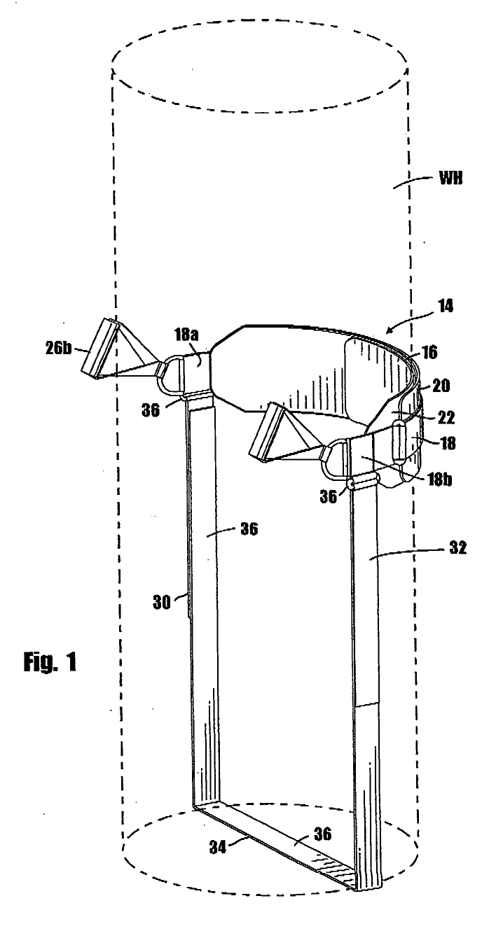

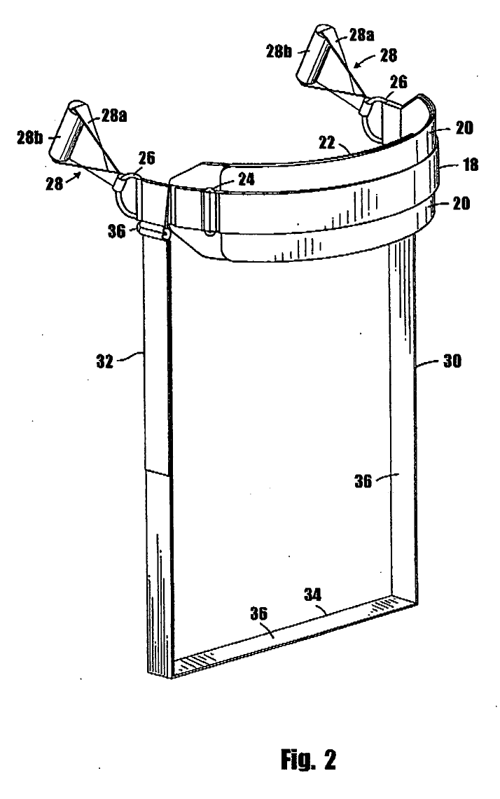

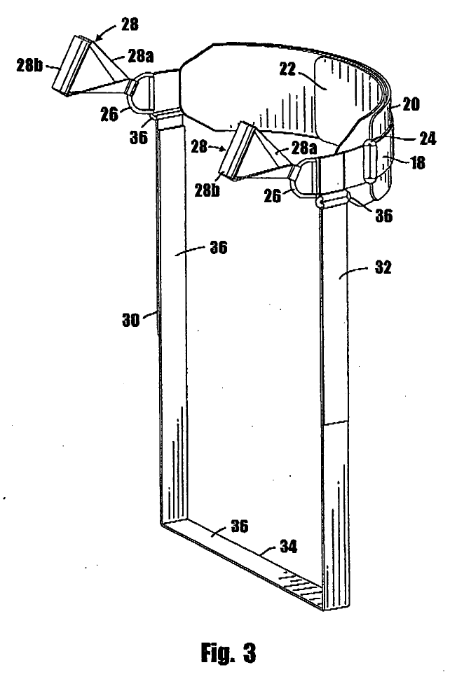

Referring to the drawings and particularly to FIGS. 1 through 5, one form of the lifting and transport strap assembly for lifting bulky articles such as hot water heaters is there illustrated and generally designated by the numeral 14. As best seen in FIGS. 1, 2 and 3, assembly 14 includes a main strap assembly 16 which is adapted to circumscribe at least a portion of the bulky article such as the hot water heater “WH” shown in FIG. 1.

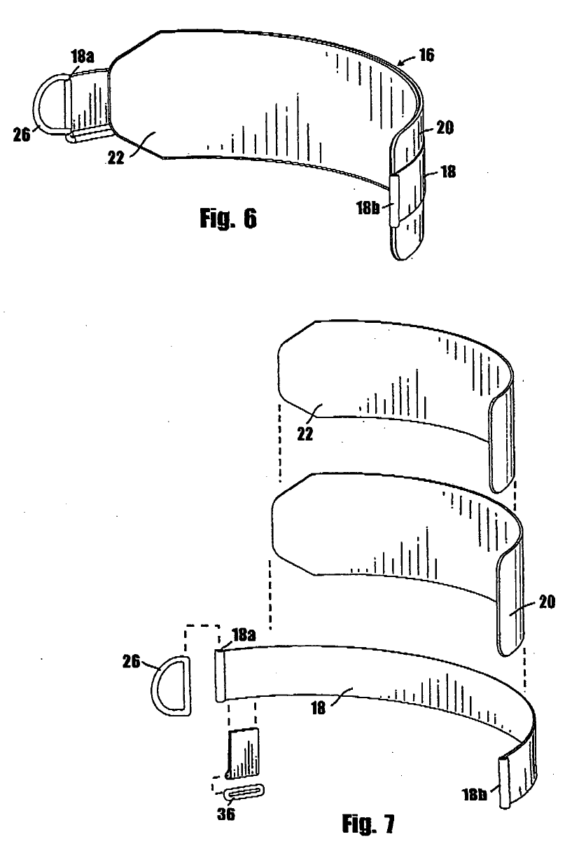

As depicted in FIGS. 5 and 7, main strap assembly 16 comprises a generally semicircular-shaped, yieldably deformable main strap 18 having spaced-apart extremities 18a and 18b, a generally semicircular-shaped, semi rigid plastic strap-like component 20 that is circumscribed by strap 18 and a generally semicircular-shaped cushioning means, shown here as a yieldably deformable foam rubber inner component 22 which is connected to plastic component 20. In use, component 22, along with component 20, functions to protect the article being lifted from damage. Component 22 also functions to frictionally grip the sides of the article such as the hot water heater “WH” shown in FIG. 1. Component 20 can be of various sizes depending upon the article to be transported, but when transporting conventional hot water heaters, component 22 is preferably about six inches in width.

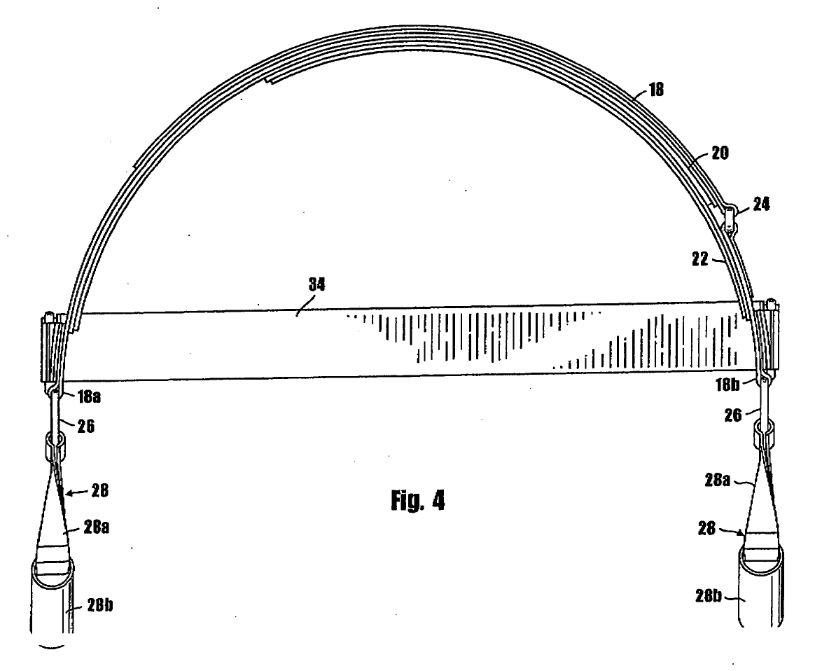

Also comprising a part of the main strap assembly 16 of the apparatus is adjustment means for adjusting the length of main strap 18 and gripping means affixed to the spaced-apart extremities of main strap 18 for gripping the main strap assembly. In the present form of the invention the adjustment means of the main strap assembly comprises a conventional buckle loop 24 that is interconnected to strap 18 in the conventional manner shown in FIGS. 4 and 5 of the drawings (see also FIG. 7). With this arrangement it is apparent that the overall length of the strap 18 can readily be adjusted to accommodate hot water heaters or other bulky articles of various sizes.

The gripping means of the present embodiment of the invention comprise generally “D”-shaped rings 26 that are affixed to the ends of strap 18 and handgrips 28 that are interconnected with rings 26 in the manner best seen in FIGS. 1, 2 and 3 of the drawings. Handgrips 28 include a flexible connector strap 28a and a generally cylindrically shaped handgrip 28b that can be conveniently and securely gripped by the installer during the lifting and transport operation. Connector straps 28a are interconnected with connector rings 26 in a manner such that the handle attachments can be angularly positioned to best accommodate the different angles of force that may be used in lifting the article to be transported.

Also forming a part of the lifting and transport strap assembly of the present invention are first and second spaced-apart side straps 30 and 32 that are connected to main strap 18 for engaging the sides of the hot water heater or other bulky article to be transported. Each the first and second side straps is connected proximate its upper end with main strap 18 and is connected proximate its lower end to a bottom strap 34 that spans the first and second side straps in a manner shown in FIG. 1. Side strap adjustment means in the form of conventional buckle loops 36 are provided on each of the side straps so that the length thereof can be adjusted to accommodate articles of various sizes. To better grip the water heater or other article being moved and to protect the article against damage, each of the side and bottom straps is provided with cushioning, or friction means here shown as a thin layer of rubber or like cushioning material 36.

In using the lifting and transport strap assembly of the invention, the main strap 18 and the side straps 30 and 32 are first appropriately adjusted using the adjustment loops 24 on 36 to fit the article to be transported so that the assembly can be placed in engagement with the article to be moved in a manner shown in FIG. 1 of the drawings. If desired, a material sold under the name and style VELCRO can be used to secure the straps in position after they have been adjusted. With the assembly in the general position shown in FIG. 1, the workmen can grasp the handles 26b and exert an inward and upward force that enables the article to be comfortably lifted and transported to a desired location with optimum leverage.

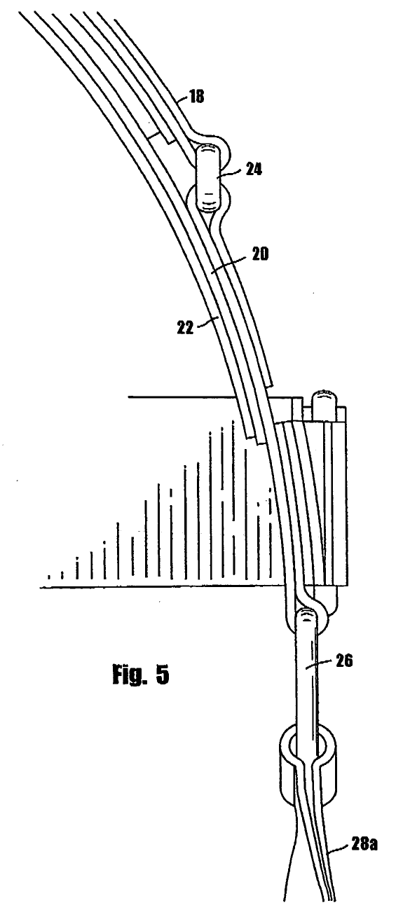

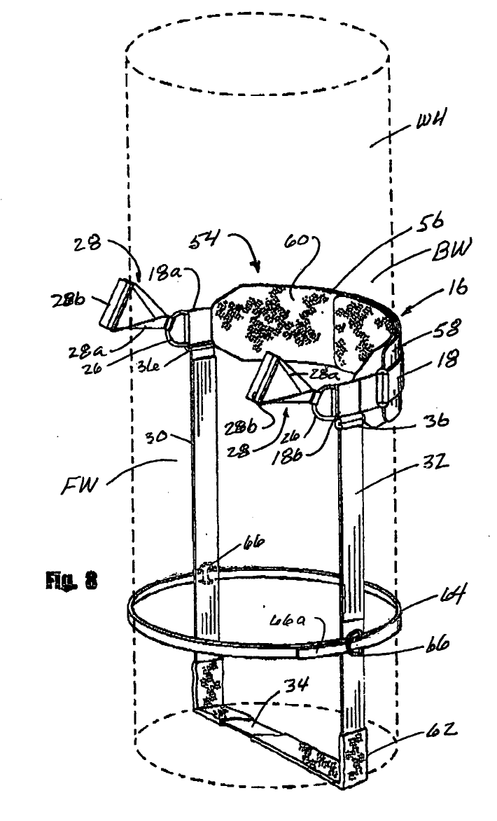

Referring now to FIGS. 8 through 10 of the drawings, an alternate form of the lifting and transport strap assembly for lifting hot water heaters having front walls “FW” and back walls “BW” (FIG. 8) is there illustrated and generally designated by the numeral 54. This alternate form of the invention is similar in many respects to that shown in FIGS. 1 through 7 of the drawings and like numerals are used in FIGS. 8 through 10 to identify like components. The main differences between this alternate form of the invention in the earlier described embodiment resides in the provision of friction surfaces at critical locations on the lifting strap and the provision of an additional securement strap that more securely interconnects the lifting strap with a hot water heater being moved.

As before, the main strap assembly 16 of this alternate embodiment comprises a generally semicircular-shaped, yieldably deformable main strap 18 having spaced-apart extremities 18a and 18b. An interior strap assembly which is generally identified in the drawings by the 56 is connected to and is circumscribed by strap 18. As shown in FIG. 8, when the lifting and transport strap is in position about the water heater, spaced-apart extremities 18a and 18b are disposed proximate the front wall “FW” of the water heater.

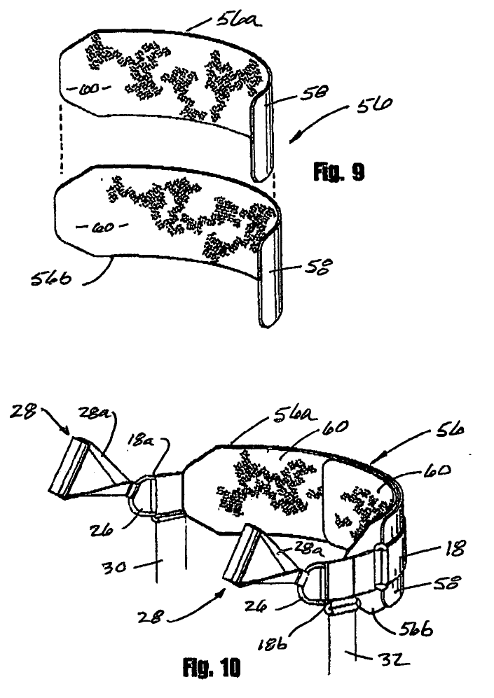

As best seen in FIG. 9 of the drawings interior strap assembly 56 is made up of two generally semicircular-shaped laminated segments 56a and 56b. Each of the segments 56a and 56b comprises inner and outer mating laminates 58 and 60. Outer laminate 58 is constructed from any suitable type of semi rigid material such as an elastomer, a plastic, or a suitable composite and inner laminate 60 is constructed from a high friction composite material such as, by way of example, an elastomer coated with a suitable pressure sensitive adhesive. Suitable materials for the construction of outer laminate 60 are available from sources such as Leggett & Platt, Inc of Carthage, Missouri and Vangard Industries of Atlanta, Ga. Inner laminate 60 functions not only to protect the inner surface of the hot water heater from damage, but also importantly functions to securely frictionally grip the outer, rear surface of the hot water in a manner so as to effectively prevent the lifting strap from accidental slippage during the water heater lifting step. As in the earlier described embodiment of the invention, strap assembly 56 can be of various sizes depending upon the article to be transported, but when transporting conventional hot water heaters is preferably about six inches in width.

The gripping means of the present embodiment of the invention comprise generally “D”-shaped rings 26 that are affixed to the ends of strap 18 and handgrips 28 that are interconnected with rings 26 in the manner best seen in FIGS. 1,2, 3 and 8 of the drawings. As shown in the drawings, handgrips 28 include flexible connector straps 28a. It is important to note that to enable the workman to properly address and grasp the handgrips during the lifting step, both the gripping rings and the gripping handles must extend forwardly of the spaced-apart extremities 18a and 18b of the main strap in the manner indicated in FIG. 8 (see also FIG. 4).

Also forming a part of the lifting and transport strap assembly of the alternate form of the apparatus of the invention are first and second spaced-apart side straps 30 and 32 that are connected to main strap 18 for engaging the sides of the hot water heater or other bulky article to be transported. Each of the first and second side straps is connected proximate its upper end with main strap 18 and is connected proximate its lower end to a bottom strap 34 that spans the first and second side straps in a manner shown in FIG. 1. Side strap adjustment means in the form of conventional buckle loops 36 are provided on each of the side straps so that the length thereof can be adjusted to accommodate articles of various sizes.

Forming an important aspect of the alternate form of the apparatus of the invention as shown in FIG. 8 of the drawings is a non-skid, high friction slip-on sleeve 62 that is received over bottom strap 34 and a portion of each of the spaced-apart side straps 30 and 32. Sleeve 62, which is preferably constructed from a non-skid gripping material such as the previously described pressure sensitive adhesive-coated rubber or elastomer composite, functions to better grip the bottom of the water heater and prevent the bottom strap from slipping relative to the bottom of the hot water heater during lifting and movement of the hot water heater.

Also forming an important safety feature of the alternate form of the present invention is the provision of a nylon securement strap 64 which is adapted to circumscribe the lower portion of the hot water heater in the manner shown in FIG. 8 of the drawings. To properly position securement strap 64 relative to the side straps 30 and 32, and to permit sliding movement of the securement strap relative to the side straps, each of the side straps is provided with a generally “D”-shaped ring 66. Following the interconnection of the lifting and transport strap of the invention with the hot water heater in the manner previously described, one end of the strap 64 is inserted into one of the rings 66, is passed around the hot water heater, inserted into the other of the rings 66 and then suitably interconnected with the other end of strap 64. While the ends of the securement strap can be interconnected in various ways, one end of the strap is here provided with a material sold under the name and style VELCRO having a multiplicity of hooks and the other end of the strap is provided with a VELCRO material having a multiplicity of loops. With this construction, once the securement strap is suitably cinched down about the hot water, the ends 66a of the strap can be interconnected in a conventional manner using the VELCRO material. Securement strap 64 along with sleeve 62 function to enable the lifting and transport strap of this alternate form of the invention to be safely and securely interconnected with a hot water heater that is to be moved and to prevent unwanted accidental slippage of the lifting and transport strap relative to the hot water heater during the lifting and movement of the hot water heater.

In using the alternate form of the lifting and transport strap assembly of the invention, the main strap 18 and the side straps 30 and 32 are first appropriately adjusted using the adjustment loops 24 on 36 to fit the article to be transported so that the assembly can be placed in engagement with the article to be moved in a manner shown in FIG. 1 of the drawings. With the assembly in the general position shown in FIG. 8, the workmen, while standing near the front wall “FW” of the hot water heater, can conveniently grasp the forwardly extending handles 26b and exert an inward and upward force that enables the article to be comfortably lifted and transported to a desired location with optimum leverage.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A lifting and transport strap assembly for lifting and transporting a hot water heater having interconnected top, bottom, front and back walls, comprising:
(a) a main strap assembly for circumscribing at least a portion of the back wall of the hot water heater, said main strap assembly comprising:
(i) a generally semicircular-shaped, yieldably deformable main strap having spaced-apart extremities disposed proximate said front wall of said water heater;
(ii) a generally semicircular-shaped, plastic component connected to said main strap;
(iii) a generally semicircular-shaped, yieldably deformable foam rubber inner component connected to said plastic component for frictionally gripping the sidewall of the hot water heater; and
(iv) first adjustment means for adjusting the length of said main strap to accommodate the hot water heater being lifted and transported.
(b) gripping means affixed into said spaced-apart extremities of said main strap for gripping said main strap assembly, said gripping means comprising gripping rings and gripping handles adjustably interconnected with said gripping rings, said gripping rings and said gripping handles extending forwardly of said spaced-apart extremities of said main strap;
(c) first and second spaced-apart side straps connected to said main strap for engaging the side of the hot water heater, each said first and second side strap having an upper end portion and a lower end portion; and
(d) a bottom strap spanning said first and second spaced-apart side straps for engaging the bottom of the hot water heater, said bottom strap being connected to said side straps proximate said lower end portions thereof.

2. The lifting and transport strap assembly as defined in claim 1 further including second adjustment means for adjusting the length of said side straps to accommodate the hot water heater being lifted and transported.

3. The lifting and transport strap assembly as defined in claim 1 in which said gripping means comprises generally “D”-shaped gripping rings interconnected with said main strap and gripping handles adjustably interconnected with said gripping rings to enable angular positioning of said gripping rings relative to the hot water heater being lifted and transported.

4. The lifting and transport strap assembly as defined in claim 1 further including a securement strap slidably interconnected with said side straps and circumscribing the hot water heater.

5. The lifting and transport strap assembly as defined in claim 1 further including a slip-on, non-skid sleeve received over said bottom strap and over a portion of each of said spaced-apart side straps.

6. A lifting and transport strap assembly for lifting and transporting a hot water heater having interconnected top, bottom, front and back walls, comprising:
(a) a main strap assembly for circumscribing at least a portion of the hot water heater, said main strap assembly comprising:
(i) a generally semicircular-shaped, yieldably deformable main strap having spaced-apart extremities;
(ii) an interior strap assembly connected to said main strap and circumscribed thereby, said interior strap assembly comprising first and second generally semicircular-shaped laminated segments for frictionally gripping the sides of the hot water heater; and
(iv) adjustment means for adjusting the length of said main strap to accommodate the hot water heater being lifted and transported.
(b) gripping means affixed into said spaced-apart extremities of said main strap for gripping said main strap assembly, said gripping means comprising gripping rings and gripping handles adjustably interconnected with said gripping rings, said gripping rings and said gripping handles extending forwardly of said spaced-apart extremities of said main strap;
(c) first and second spaced-apart side straps connected to said main strap for engaging the sides of the hot water heater, each said first and second side strap having an upper end portion and a lower end portion; and
(d) a bottom strap spanning said first and second spaced-apart side straps for engaging the bottom of the hot water heater, said bottom strap being connected to said side straps proximate said lower end portions thereof and have a layer of foam rubber affixed thereto;
(e) a securement strap slidably interconnected with said side straps and circumscribing the hot water heater; and
(f) a slip-on, non-skid sleeve received over said bottom strap and over a portion of each of said spaced-apart side straps.

7. The lifting and transport strap assembly as defined in claim 6 in which said gripping means comprises generally “D”-shaped gripping rings interconnected with said main strap and gripping handles adjustably interconnected with said gripping rings.

8. The lifting and transport assembly as defined in claim 6 in which each of said first and second generally semicircular-shaped laminated segments of said interior assembly comprises inner and outer mating laminates, said inner laminate comprising a semi-rigid material and said outer laminate comprising a non-skid material.
